(19) United States
(12) Patent Application Publication
(10) Pub. No.: US 2024/0330794 A1
(43) Pub. Date: Oct. 3, 2024

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Ryogo NONAKA, Kawasaki-shi (JP); Ai MIYATA, Hirakata-shi (JP); Keisuke OKAMOTO, Chofu-shi (JP); Yuka TAKIGUCHI, Fukaya-shi (JP); Nahoko SHIBANO, Tokyo (JP); Yuta SHISHIME, Tokyo (JP); Tsuyoshi OKADA, Nagoya-shi (JP); Shota KOMATSU, Kobe-shi (JP)

(73) Assignee: TOYOTA JIDOSHA KABUSHIKI KAISHA, Toyota-shi (JP)

(21) Appl. No.: 18/615,669

(22) Filed: Mar. 25, 2024

(30) Foreign Application Priority Data
Mar. 29, 2023 (JP) 2023-054206

(51) Int. Cl. G06Q 10/0631; G06Q 30/0202; G06Q 30/0251

(52) U.S. Cl. CPC G06Q 10/06311; G06Q 30/0202; G06Q 30/0267

(57) ABSTRACT

An information processing apparatus, an information processing method, or a non-transitory storage medium plans a service schedule of vehicles that transport visitors to an event site. The apparatus includes a processor configured to execute: receiving advance purchase of goods sold in the event site from the visitors; setting a threshold for a total value of upper limit numbers of people up to which the goods can be handed over per predetermined period of time respectively at one or more shops at the event site; when the number of goods purchasers purchased the goods in advance exceeds the threshold, distributing the goods purchasers such that the goods purchasers in number smaller than or equal to the threshold get a ride on each vehicle; and planning the service schedule of the vehicles such that the number of goods purchasers who concurrently arrive at the event site does not exceed the threshold.

### CROSS-REFERENCE TO RELATED APPLICATION

This application claims priority to Japanese Patent Application No. 2023-054206 filed on Mar. 29, 2023, incorporated herein by reference in its entirety.

### BACKGROUND

### 1. Technical Field

The disclosure relates to an information processing apparatus, an information processing method, and a non-transitory storage medium.

### 2. Description of Related Art

Hitherto, there is known a technology for reducing congestion at an event site. At an event site, goods, food and drink, or the like are generally sold, and visitors do not need to bring goods or the like from home, so it is highly convenient for the visitors. Here, to reduce congestion at an event site, for example, a method of accepting arrangements for purchase of goods to be sold at the event site in advance by electronic payment is adopted.

In addition, to reduce congestion at an event site, for example, Japanese Unexamined Patent Application Publication No. 2022-080651 (JP 2022-080651 A) describes a technology for transporting visitors who participate in an event to the event site.

### SUMMARY

However, receipt of goods is still performed at the event site, so, if the number of visitors who purchased goods in advance (hereinafter, referred to as goods purchasers) is large, goods purchasers waiting for receipt of goods line up. This is one of factors of congestion at the event site.

Therefore, there is room for improvement in the technology for reducing congestion at an event site.

The disclosure improves a technology for reducing congestion at an event site.

A first aspect of the disclosure relates to an information processing apparatus. The information processing apparatus plans a service schedule of a plurality of vehicles that transport a plurality of visitors to an event site. The information processing apparatus includes a processor. The processor is configured to execute: receiving advance purchase of goods to be sold at the event site from the plurality of visitors; setting a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing the goods purchasers such that the goods purchasers in number smaller than or equal to the threshold get a ride on each of the plurality of vehicles; and planning the service schedule of the plurality of vehicles such that the number of goods purchasers who concurrently arrive at the event site does not exceed the threshold.

A second aspect of the disclosure relates to an information processing method. The information processing method is executed by an information processing apparatus that plans a service schedule of a plurality of vehicles that transport a plurality of visitors to an event site. The information processing apparatus includes a processor and a memory. The information processing method includes: receiving, by the processor, advance purchase of goods to be sold at the event site from the plurality of visitors; setting, by the processor, a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing, by the processor, the goods purchasers such that the goods purchasers in number smaller than or equal to the threshold get a ride on each of the plurality of vehicles; and planning, by the processor, the service schedule of the plurality of vehicles such that the number of goods purchasers who concurrently arrive at the event site does not exceed the threshold.

A third aspect of the disclosure relates to a non-transitory storage medium storing instructions. The instructions are executable on a processor included in an information processing apparatus that is configured to plan a service schedule of a plurality of vehicles that transport a plurality of visitors to an event site. The instructions cause the processor to execute functions. The functions include: receiving advance purchase of goods to be sold at the event site from the plurality of visitors; setting a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing the goods purchasers such that the goods purchasers in number smaller than or equal to the threshold get a ride on each of the plurality of vehicles; and planning the service schedule of the plurality of vehicles such that the number of goods purchasers who concurrently arrive at the event site does not exceed the threshold.

According to the aspects of the disclosure, a technology for reducing congestion at an event site is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram that shows the schematic configuration of a system according to an embodiment of the disclosure;

FIG. 2 is a flowchart that shows the operations of an information processing apparatus;

FIG. 3 is a schematic view that shows a configuration to shift departure time and arrival time of each of a plurality of vehicles; and

FIG. 4 is a schematic view that shows a configuration to designate, for each of the vehicles, a shop at which each goods purchaser receives goods.

### DETAILED DESCRIPTION OF EMBODIMENTS

Hereinafter, an embodiment of the disclosure will be described.

### Outline of Embodiment

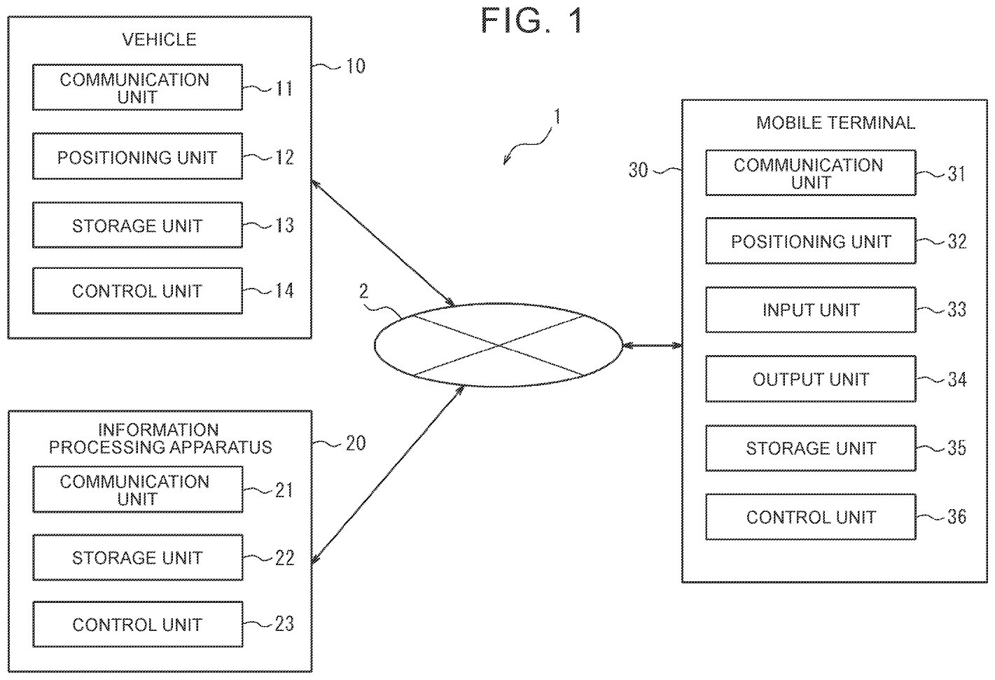

The outline of a system 1 according to the embodiment of the disclosure will be described with reference to FIG. 1. The system 1 includes a vehicle 10, an information processing apparatus 20, and a mobile terminal 30. The vehicle 10, the information processing apparatus 20, and the mobile terminal 30 are connected to a network 2 such that communication is possible. Examples of the network 2 include the Internet and a mobile communication network.

The vehicle 10 is, for example, an automobile; however, the vehicle 10 is not limited thereto and may be any vehicle. Examples of the automobile include a gasoline vehicle, a battery electric vehicle (BEV), a hybrid electric vehicle (HEV), a plug-in hybrid electric vehicle (PHEV), and a fuel cell electric vehicle (FCEV); however, the automobile is not limited thereto. The number of vehicles 10 included in the system 1 may be selectively determined.

In the present embodiment, the vehicle 10 transports a plurality of visitors to an event site. The vehicles 10 in number according to the number of visitors may be configured to be operated with shifted departure time, shifted arrival time, or shifted departure time and arrival time. The vehicle 10 may be configured to be operated in a section from a predetermined departure place, such as a station square, to the event site. When the event site has a plurality of entrances (gates), the vehicle 10 may be configured to arrive in front of each of the gates. The vehicle 10 is connected to the information processing apparatus 20 via the network 2 such that communication is possible.

The information processing apparatus 20 is, for example, a computer, such as a server apparatus. The information processing apparatus 20 is connected to the vehicle 10 and the mobile terminal 30 via the network 2 such that communication is possible.

Examples of the mobile terminal 30 include a mobile phone, a smartphone, a tablet, and a personal computer (PC), held by a visitor. The mobile terminal 30 is connected to the vehicle 10 and the information processing apparatus 20 via the network 2 such that communication is possible.

The outline of the present embodiment will be described first, and the details will be described later. The information processing apparatus 20 receives advance purchase of goods to be sold at the event site from the plurality of visitors, sets a threshold for a total value of upper limit numbers of people, the upper limit number being a number up to which the goods can be handed over per a predetermined period of time at each of one or more shops at the event site, when the number of goods purchasers purchased the goods in advance exceeds the threshold, distributes the goods purchasers such that the goods purchasers in number smaller than or equal to the threshold get a ride on each of the plurality of vehicles; and plans a service schedule of the plurality of vehicles such that the number of goods purchasers who concurrently reach the event site does not exceed the threshold.

In this way, according to the present embodiment, when the number of goods purchasers purchased goods in advance exceeds the threshold, goods purchasers in number smaller than or equal to the threshold are distributed to each of the vehicles 10, with the result that the number of goods purchasers who concurrently arrive at the event site can be made smaller than or equal to the threshold. For this reason, the line of goods purchasers who receive goods at one or more shops at the event site is eliminated every predetermined period of time. Therefore, in terms that the probability that the line of people waiting for receipt of goods at the event site extends beyond an upper limit reduces, a technology for reducing congestion at the event site is improved.

Next, the components of the system 1 will be described in detail.

### Configuration of Vehicle

As shown in FIG. 1, the vehicle 10 includes a communication unit 11, a positioning unit 12, a storage unit 13, and a control unit 14.

The communication unit 11 includes one or more communication interfaces for connection with the network 2. The communication interface supports, for example, a mobile communication standard, such as 4th Generation (4G) and 5th Generation (5G); however, the communication interface is not limited thereto. In the present embodiment, the vehicle 10 communicates with the information processing apparatus 20 via the communication unit 11 and the network 2.

The positioning unit 12 includes one or more devices that acquire information about the position of the vehicle 10. Specifically, the positioning unit 12 includes, for example, a receiver that supports GPS; however, the configuration is not limited thereto. The positioning unit 12 may include a receiver that supports a selected satellite positioning system.

The storage unit 13 includes one or more memories. Examples of the memory include a semiconductor memory, a magnetic memory, and an optical memory; however, the memory is not limited thereto. Each memory included in the storage unit 13 may function as, for example, a main storage device, an auxiliary storage device, or a cache memory. The storage unit 13 stores selected information used in the operation of the vehicle 10. For example, the storage unit 13 may store a system program, an application program, embedded software, a service schedule of the host vehicle, received from the information processing apparatus 20, identification information of a plurality of visitors who get a ride on the host vehicle, and the like. Information stored in the storage unit 13 may be allowed to be updated with, for example, information acquired from the network 2 via the communication unit 11.

The control unit 14 includes one or more processors, one or more programmable circuits, one or more dedicated circuits, or a combination of them. The processor is, for example, a general-purpose processor, such as a central processing unit (CPU) and a graphics processing unit (GPU), or a special-purpose processor specialized in a specific process; however, the processor is not limited thereto. The programmable circuit is, for example, a field-programmable gate array (FPGA); however, the programmable circuit is not limited thereto. The dedicated circuit is, for example, an application specific integrated circuit (ASIC); however, the dedicated circuit is not limited thereto. The control unit 14 controls the overall operation of the vehicle 10.

### Configuration of Information Processing Apparatus

As shown in FIG. 1, the information processing apparatus 20 includes a communication unit 21, a storage unit 22, and a control unit 23.

The communication unit 21 includes one or more communication interfaces for connection with the network 2. The communication interface supports, for example, a mobile communication standard, a wired local area network (LAN) standard, or a wireless LAN standard; however, the standard supported by the communication interface is not limited thereto. The communication interface may support a selected communication standard. In the present embodiment, the information processing apparatus 20 communicates with the vehicle 10 and the mobile terminal 30 via the communication unit 21 and the network 2.

The storage unit 22 includes one or more memories. Each memory included in the storage unit 22 may function as, for example, a main storage device, an auxiliary storage device, or a cache memory. The storage unit 22 stores selected information used in the operation of the information processing apparatus 20. For example, the storage unit 22 may store a system program, an application program, a database, a service schedule of the vehicles 10, information associating identification information of each of the visitors that get a ride on the vehicles 10 with a visit history, and a goods purchase history at each visit with one another, and the like. Information stored in the storage unit 22 may be allowed to be updated with, for example, information acquired from the network 2 via the communication unit 21.

The control unit 23 includes one or more processors, one or more programmable circuits, one or more dedicated circuits, or a combination of them. The control unit 23 controls the overall operation of the information processing apparatus 20.

### Configuration of Mobile Terminal

As shown in FIG. 1, the mobile terminal 30 includes a communication unit 31, a positioning unit 32, an input unit 33, an output unit 34, a storage unit 35, and a control unit 36.

The communication unit 31 is configured to include at least one communication module connectable with the network 2. The communication module supports, for example, a mobile communication standard, such as LTE, 4G, and 5G. The communication module is not limited to these examples. The communication module may support a selected communication standard.

The positioning unit 32 is capable of acquiring information about the position of the mobile terminal 30. The positioning unit 32 is configured to include at least one receiving module that supports a satellite positioning system. The receiving module is, for example, a receiving module that supports GPS. The receiving module is not limited thereto. The receiving module may be a receiving module that supports a selected satellite positioning system.

The input unit 33 is configured to include at least one input interface capable of receiving input from a visitor. Examples of the input interface include a physical key, a capacitance key, a pointing device, a touch screen integrated with a display, and a microphone. The input interface is not limited thereto.

The output unit 34 is capable of outputting data. The output unit 34 is configured to include at least one output interface capable of outputting data. Examples of the output interface include a display and a speaker. Examples of the display include an LCD and an organic EL display. The output interface is not limited thereto.

The storage unit 35 includes one or more memories. Examples of the memory include a semiconductor memory, a magnetic memory, and an optical memory; however, the memory is not limited thereto. Each memory included in the storage unit 35 may function as, for example, a main storage device, an auxiliary storage device, or a cache memory. The storage unit 35 stores selected information used in the operation of the mobile terminal 30. For example, the storage unit 35 may store a system program, an application program, embedded software, a ticket for an event, an order number of goods purchased in advance, and the like. Information stored in the storage unit 35 may be allowed to be updated with, for example, information acquired from the network 2 via the communication unit 31.

The control unit 36 includes at least one processor, at least one dedicated circuit, or any combination of them. The control unit 36 executes a process related to the operation of the mobile terminal 30 while controlling the units of the mobile terminal 30.

### Operation Flow of Information Processing Apparatus

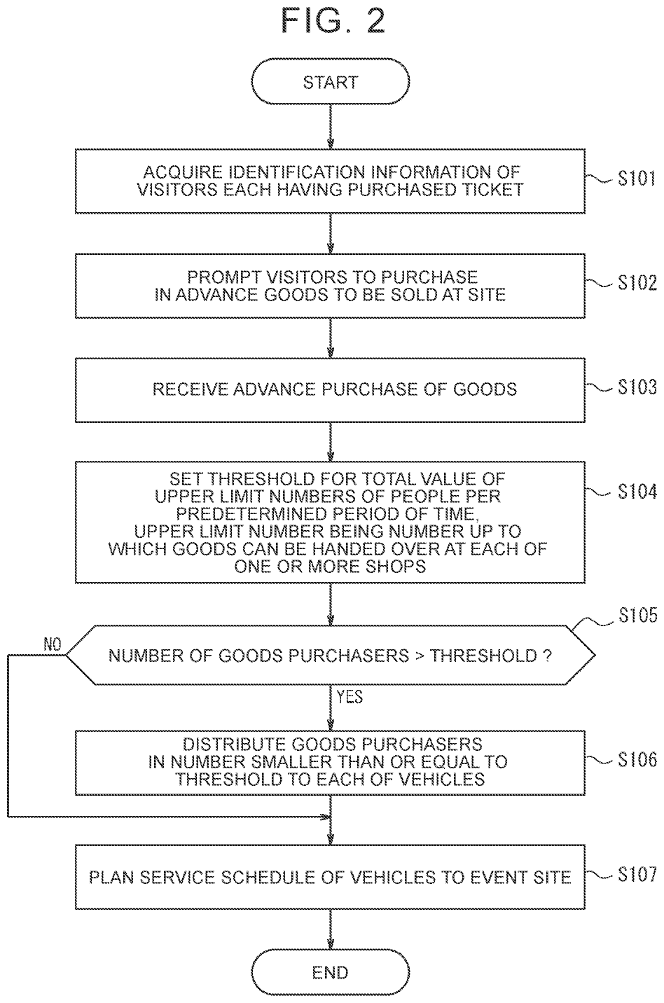

The operation of the information processing apparatus 20 according to the present embodiment will be described with reference to FIG. 2. The operation relates to planning a service schedule of the vehicles 10 that transport a plurality of visitors to the event site.

In step S101, the control unit 23 acquires identification information of a plurality of visitors who respectively purchased tickets for an event.

The information processing apparatus 20 includes the communication unit 21 connected to the mobile terminal 30 such that communication is possible. Each of the visitors holds the mobile terminal 30. The control unit 23 acquires identification information of the plurality of visitors from a server of a dealer that sells tickets for an event via the communication unit 21 and the network 2.

In step S102, the control unit 23 prompts the plurality of visitors to purchase in advance goods to be sold at the event site.

The control unit 23 prompts each visitor purchased a ticket for the event to purchase goods to be sold at the event site in advance by sending information for moving to a dedicated page for purchasing the goods to the mobile terminal 30 of the visitor via the communication unit 21 and the network 2.

In step S103, the control unit 23 receives advance purchase of goods to be sold at the event site from the plurality of visitors.

The control unit 23 receives advance purchase of goods, applied from the dedicated page shown on the display screen of the mobile terminal 30 of each of the visitors via the communication unit 21 and the network 2, makes payment for the purchase, and sends a receipt and information, such as an order number to be presented at the time of receiving goods at the event site, to the mobile terminal 30.

The storage unit 22 may record identification information of the plurality of visitors, a visit history, and a goods purchase history at each visit in association with one another. The storage unit 22 may record a visit history and a goods purchase history this time by adding the visit history and the goods purchase history to a past visit history and a past goods purchase history stored in the storage unit 22 for each individual visitor in association with one another based on the identification information of the plurality of visitors, acquired from the server of the dealer.

In step S104, the control unit 23 sets a threshold for a total value of upper limit numbers of people. The upper limit number is a number up to which goods can be handed over per a predetermined period of time T at each of one or more shops at the event site.

At the event site, one or more shops that hand over goods purchased in advance are placed in accordance with a visitor capacity, the size of the site, and the like. To reduce congestion due to goods purchasers lining up at each shop, the upper limit number of people that goods can be handed over per the predetermined period of time T is determined shop by shop. The predetermined period of time T means a required period of time uniformly set for all the shops to hand over goods to all the goods purchasers lining up. The predetermined period of time T is set to 10 minutes in the present embodiment for the sake of convenience of description; however, the predetermined period of time T is not limited to 10 minutes and may be selectively determined. Therefore, the upper limit number of people that goods can be handed over in the predetermined period of time T depends on the capability of each shop. The threshold means a numeric value obtained by adding up the upper limit numbers of people. The upper limit number is a number up to which goods can be handed over per the predetermined period of time T at each of one or more shops. For example, if a shop 6A and a shop 6B are placed at the event site and the upper limit number of people up to which goods can be handed over per the predetermined period of time T is 10 at the shop 6A and eight at the shop 6B, the threshold is 18.

In step S105, the control unit 23 determines whether the number of goods purchasers exceeds the threshold.

A goods purchaser means a person who is a visitor and who purchased goods in advance.

In step S106, when the number of goods purchasers purchased goods in advance exceeds the threshold, the control unit 23 distributes the goods purchasers to a plurality of vehicles such that goods purchasers in number smaller than or equal to the threshold get a ride on each of the vehicles.

The plurality of vehicles is obtained by rounding up a value to the closest whole number, and the value is obtained by dividing the number of goods purchasers by the threshold. If the vehicle 10 on which goods purchasers in number exceeding the threshold are riding arrives at the event site, the goods purchasers line up for the predetermined period of time T or longer at one or more shops to receive goods, so congestion occurs at the event site. The control unit 23 distributes goods purchasers in number smaller than or equal to the threshold to each of the vehicles to reduce congestion due to goods purchasers lining up.

The control unit 23 may estimate the number of visitors who have not purchased goods in advance and who have purchased goods in the same category as the goods at any one of event sites before (hereinafter, referred to as prospective customers) based on the goods purchase history at each visit of each of the plurality of visitors, stored in the storage unit 22. When the total number of goods purchasers and prospective customers exceeds the threshold, the control unit 23 may distribute goods purchasers in number smaller than or equal to the threshold, prospective customers in number smaller than or equal to the threshold, or a combination of goods purchasers and prospective customers in number smaller than or equal to the threshold, to each of the plurality of vehicles.

A prospective customer may be regarded as a visitor that has not purchased goods yet, that has an interest in the goods to some extent, and that may purchase the goods sometime. For example, it is assumed that a visitor 3A has purchased a support flag for supporting a team X at a last sporting event. When the team X participates in an event this time, the visitor 3A may purchase a support flag for supporting the team X at the event site even when the visitor 3A has not purchased the support flag in advance. In this case, the visitor 3A is regarded as a prospective customer.

As in the case of goods purchasers, prospective customers may also line up to wait for purchase of goods at the event site, so goods purchasers and prospective customers may be distributed to each of the plurality of vehicles such that the number of goods purchasers, the number of prospective customers, or the number of a combination of goods purchasers and prospective customers is smaller than or equal to the threshold.

In step S107, the control unit 23 plans a service schedule of the vehicles 10 such that the number of goods purchasers that concurrently arrive at the event site does not exceed the threshold. A specific example of a service schedule that satisfies the above condition will be described below.

The vehicles 10 are assumed to transport visitors from a predetermined departure place to the event site. When the number of goods purchasers exceeds the threshold, the control unit 23 may plan a service schedule of the vehicles 10 such that departure time from the predetermined departure place and arrival time at the event site of each of the vehicles 10 are shifted by at least the predetermined period of time T.

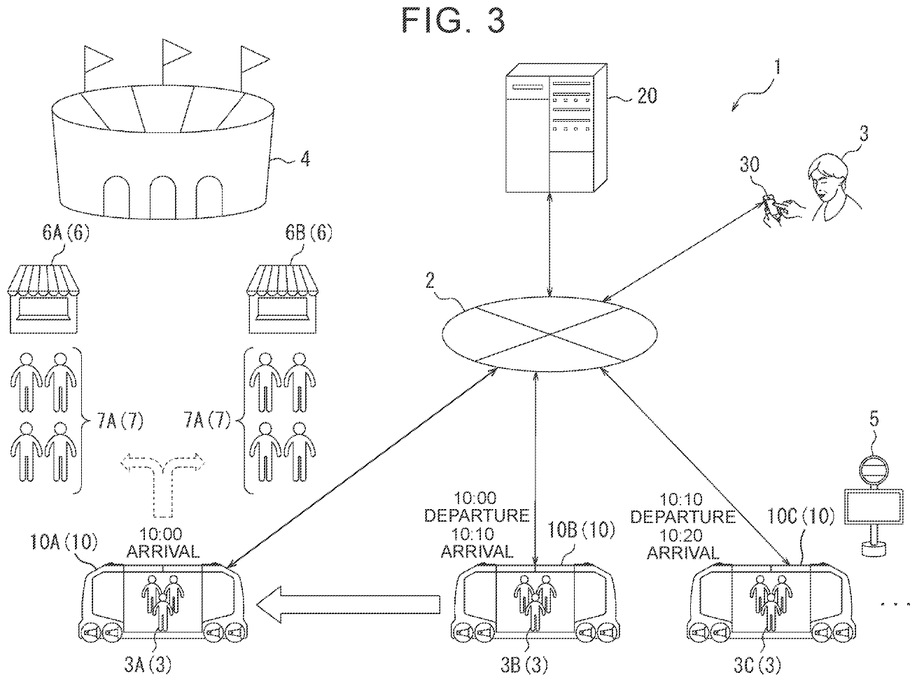

FIG. 3 is a schematic view that shows a configuration to shift departure time and arrival time of each of the vehicles 10. In the present embodiment, it is assumed that transportation to an event site 4 is only the vehicles 10. As shown in FIG. 3, the vehicles 10 (for example, three vehicles 10A, 10B, 10C) are operated at intervals of 10 minutes by which departure time from a departure place 5 and arrival time at the event site 4 are shifted. In this way, there is no chance that the number of goods purchasers 7 that concurrently arrive at the event site 4 exceeds the threshold. When the vehicle 10A arrives at the event site 4, goods purchasers 7A (it is assumed that there is a plurality of goods purchasers 7A) of visitors 3A on the vehicle 10A move to any one of a shop 6A and a shop 6B that are all the shops 6 at the event site 4. For example, when the total number of people that line up at the shop 6A reaches the upper limit number of people up to which goods can be handed over per the predetermined period of time T at the shop 6A, the goods purchasers 7A in excess number move to the other shop 6B at which the total number of people that line up has not reached the upper limit number of people yet. Since the total number of goods purchasers 7A that concurrently arrived at the event site 4 is limited to the threshold or smaller, all the goods purchasers 7A are able to receive goods in the predetermined period of time T (in 10 minutes). In FIG. 3, the wide continuous arrow represents the operation of the vehicle 10A, and the wide dashed arrow represents movement of goods purchasers 7A on foot. In FIG. 3, the shops 6A, 6B are placed outside the event site 4. Alternatively the shops 6A, 6B may be placed inside the event site 4.

In this way, when a service schedule of the vehicles 10 is planned such that the vehicles 10 on which goods purchasers 7 in number smaller than or equal to the threshold are riding arrive at the event site 4 at intervals of at least the predetermined period of time T (10 minutes), the goods purchasers 7 are able to receive goods in the predetermined period of time T at one or more shops 6, so congestion at the event site 4 is reduced.

When the number of goods purchasers exceeds the threshold, the control unit 23 may plan a service schedule of the vehicles 10 by designating, for each of the vehicles 10, the shop 6 at which the goods purchasers 7 receive goods.

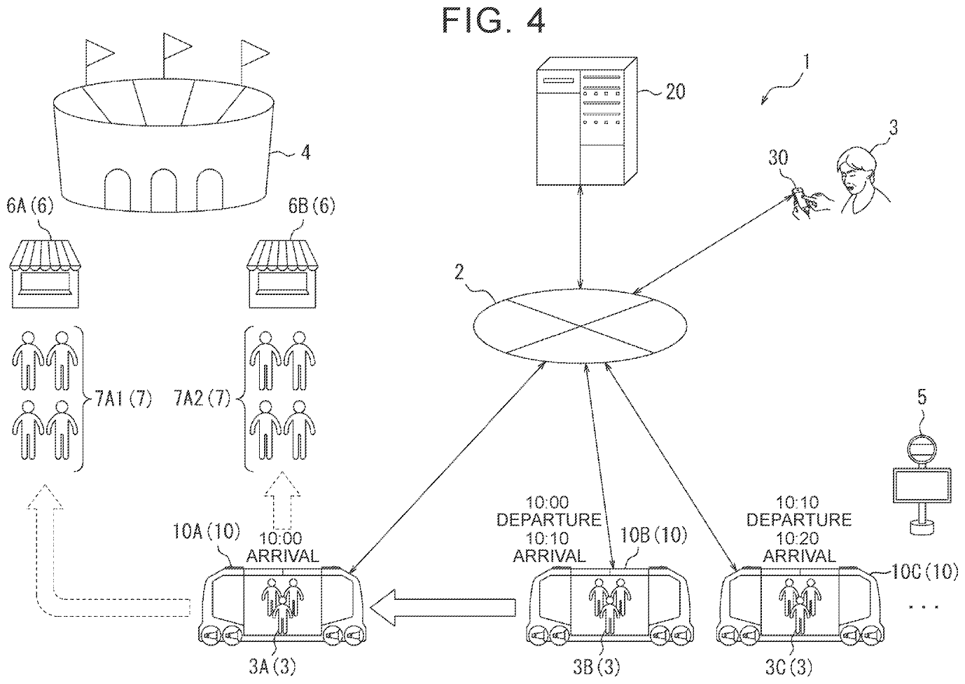

The control unit 23 may designate, for each of the vehicles 10, the shop 6 at which goods purchasers 7 on the vehicle 10 receive goods. In FIG. 4, when the shop at which the goods purchasers 7A on the vehicle 10A receive goods is designated as the shop 6A, the goods purchasers 7A move to the shop 6A when the vehicle 10A arrives at the event site 4. Alternatively, the goods purchasers 7A on the vehicle 10A may be divided into a plurality of groups, and the shop at which the goods purchasers 7A receive goods may be designated for each group. For example, the shops are designated such that goods purchasers 7A1 riding on the vehicle 10A receive goods at the shop 6A and goods purchasers 7A2 riding on the vehicle 10A receive goods at the shop 6B. With the above configuration, since the number of goods purchasers 7 that concurrently arrive at the event site 4 is smaller than or equal to the threshold, goods can be handed over to the goods purchasers 7 in the predetermined period of time T. In addition, the goods purchasers 7 do not walk around in the event site 4, so a technology for reducing congestion at the event site 4 is further improved in terms that a traffic line along which the goods purchasers 7 move to the designated shop 6 is shortened.

The information processing apparatus 20 according to the present embodiment receives advance purchase of goods to be sold at the event site 4 from the plurality of visitors, sets a threshold for a total value of upper limit numbers of people, the upper limit number being a number up to which the goods can be handed over per the predetermined period of time T at each of one or more shops 6 at the event site 4, when the number of goods purchasers 7 purchased the goods in advance exceeds the threshold, distributes the goods purchasers 7 such that the goods purchasers 7 in number smaller than or equal to the threshold get a ride on each of the plurality of vehicles 10; and plans a service schedule of the plurality of vehicles 10 such that the number of goods purchasers 7 who concurrently arrive at the event site 4 does not exceed the threshold.

With the above configuration, when the number of goods purchasers 7 purchased goods in advance exceeds the threshold, goods purchasers 7 in number smaller than or equal to the threshold can be distributed to each of the vehicles 10, and the number of goods purchasers 7 who concurrently arrive at the event site 4 can be made smaller than or equal to the threshold. For this reason, the line of goods purchasers 7 who receive goods at one or more shops 6 at the event site 4 is eliminated every predetermined period of time T. Therefore, in terms that the probability that the line of people waiting for receipt of goods at the event site 4 extends beyond an upper limit reduces, a technology for reducing congestion at the event site 4 is improved.

The disclosure has been described based on the drawings and the embodiment, and it is noted that persons skilled in the art can make various modifications and alterations based on the disclosure. Therefore, it should be noted that the scope of the disclosure encompasses these modifications and alterations. For example, the functions and the like included in the components, steps, or the like, may be rearranged without any logical contradiction, and a plurality of components, steps, or the like may be combined as one or each component, step, or the like may be divided.

For example, in the above-described embodiment, an embodiment in which the configuration and operation of the information processing apparatus 20 are distributed to a plurality of computers such that communication is possible with one another is applicable. An embodiment in which one or some of the component elements of the information processing apparatus 20 are provided in the vehicle 10 is also applicable. For example, an operation to receive advance purchase of goods to be sold at an event site may be disposed in a distributed manner between the control unit 23 of the information processing apparatus 20 and the control unit 14 of the vehicle 10.

In the above-described embodiment, the control unit 23 plans a service schedule in which the vehicles 10 are operated to an event site one by one. However, the control unit 23 may plan a service schedule in which two or more vehicles 10 concurrently arrive at an event site while goods purchasers in number smaller than or equal to the threshold are riding on the vehicles 10 in a distributed manner.

For example, a general-purpose computer may be configured to function as the information processing apparatus 20 according to the above-described embodiment. Specifically, a program describing the process details to implement the functions of the information processing apparatus 20 according to the above-described embodiment is stored in a memory of a general-purpose computer, and the program is read and run by a processor. The disclosure may be implemented by a program executable on a processor or a non-transitory computer-readable medium storing the program.

Hereinafter, some of embodiments of the disclosure will be described. However, embodiments of the disclosure are not limited to these embodiments.

### Addendum 1

An information processing apparatus plans a service schedule of a plurality of vehicles that transport a plurality of visitors to an event site. The information processing apparatus includes a processor. The processor is configured to execute: receiving advance purchase of goods to be sold at the event site from the plurality of visitors; setting a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing the goods purchasers such that the goods purchasers in number smaller than or equal to the threshold get a ride on each of the plurality of vehicles; and planning the service schedule of the plurality of vehicles such that the number of goods purchasers who concurrently arrive at the event site does not exceed the threshold.

### Addendum 2

The information processing apparatus according to Addendum 1 may further include a communication unit communicably connected to mobile terminals held by the visitors and the communication unit may be configured to send information to the mobile terminals to prompt the visitors to purchase the goods in advance, the information being information for moving to a dedicated page for purchasing the goods.

### Addendum 3

In the information processing apparatus according to Addendum 1 or 2, the plurality of vehicles may transport visitors from a predetermined departure place to the event site; and the processor may be configured to, when the number of the goods purchasers exceeds the threshold, shift, at least by the predetermined period of time, departure time from the predetermined departure place and arrival time at the event site of each of the plurality of vehicles.

### Addendum 4

In the information processing apparatus according to any one of Addenda 1 to 3, the processor may be configured to, when the number of the goods purchasers exceeds the threshold, designate, for each of the vehicles, a shop at which each of the goods purchasers receives the goods.

### Addendum 5

In the information processing apparatus according to any one of Addenda 1 to 4, the number of the plurality of vehicles may be obtained by rounding up a value to the closest whole number, the value being obtained by dividing the number of the goods purchasers by the threshold.

### Addendum 6

The information processing apparatus according to any one of Addenda 1 to 5 may further include a memory configured to record identification information of each of the plurality of visitors, a visit history, and a goods purchase history at each visit in association with one another.

### Addendum 7

In the information processing apparatus according to Addendum 6, the processor may be configured to estimate the number of prospective customers that have not purchased the goods in advance and that have purchased goods in the same category as the goods at any one of event sites before, based on the goods purchase history at each visit of each of the plurality of visitors, and, when a total of the number of the goods purchasers and the number of the prospective customers exceeds the threshold, distribute the goods purchasers and the prospective customers such that the goods purchasers in number smaller than or equal to the threshold, the prospective customers in number smaller than or equal to the threshold, or a combination of the goods purchasers and the prospective customers in number smaller than or equal to the threshold get a ride on each of the plurality of vehicles.

### Addendum 8

An information processing method is executed by an information processing apparatus that plans a service schedule of a plurality of vehicles that transport a plurality of visitors to an event site. The information processing apparatus includes a processor and a memory. The information processing method includes: receiving, by the processor, advance purchase of goods to be sold at the event site from the plurality of visitors; setting, by the processor, a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing, by the processor, the goods purchasers such that the goods purchasers in number smaller than or equal to the threshold get a ride on each of the plurality of vehicles; and planning, by the processor, the service schedule of the plurality of vehicles such that the number of goods purchasers who concurrently arrive at the event site does not exceed the threshold.

### Addendum 9

The information processing method according to Addendum 8 may further include sending, by the processor, information to mobile terminals held by the visitors to prompt the visitors to purchase the goods in advance, the information being information for moving to a dedicated page for purchasing the goods.

### Addendum 10

In the information processing method according to Addendum 8 or 9, the plurality of vehicles may transport visitors from a predetermined departure place to the event site; and the information processing method may further include, when the number of the goods purchasers exceeds the threshold, shifting, by the processor, at least by the predetermined period of time, departure time from the predetermined departure place and arrival time at the event site of each of the plurality of vehicles.

### Addendum 11

The information processing method according to any one of Addenda 8 to 10 may further include, when the number of the goods purchasers exceeds the threshold, designating, by the processor, for each of the vehicles, a shop at which each of the goods purchasers receives the goods.

### Addendum 12

In the information processing method according to any one of Addenda 8 to 11, the number of the plurality of vehicles may be obtained by rounding up a value to the closest whole number, the value being obtained by dividing the number of the goods purchasers by the threshold.

### Addendum 13

The information processing method according to any one of Addenda 8 to 12 may further include recording, by the memory, identification information of each of the plurality of visitors, a visit history, and a goods purchase history at each visit in association with one another.

### Addendum 14

The information processing method according to Addendum 13 may further include estimating, by the processor, the number of prospective customers that have not purchased the goods in advance and that have purchased goods in the same category as the goods at any one of event sites before, based on the goods purchase history at each visit of each of the plurality of visitors; and, when a total of the number of the goods purchasers and the number of the prospective customers exceeds the threshold, distributing, by the processor, the goods purchasers and the prospective customers such that the goods purchasers in number smaller than or equal to the threshold, the prospective customers in number smaller than or equal to the threshold, or a combination of the goods purchasers and the prospective customers in number smaller than or equal to the threshold get a ride on each of the plurality of vehicles.

### Addendum 15

A non-transitory storage medium stores instructions. The instructions are executable on a processor included in an information processing apparatus that is configured to plan a service schedule of a plurality of vehicles that transport a plurality of visitors to an event site. The instructions cause the processor to execute functions. The functions include: receiving advance purchase of goods to be sold at the event site from the plurality of visitors; setting a threshold for a total value of upper limit numbers of people, the upper limit number being a number up to which the goods can be handed over per a predetermined period of time at each of one or more shops at the event site; when the number of goods purchasers purchased the goods in advance exceeds the threshold, distributing the goods purchasers such that the goods purchasers in number smaller than or equal to the threshold get a ride on each of the plurality of vehicles; and planning the service schedule of the plurality of vehicles such that the number of goods purchasers who concurrently arrive at the event site does not exceed the threshold.

### Addendum 16

In the non-transitory storage medium according to Addendum 15, the functions may further include sending information to mobile terminals held by the visitors to prompt the visitors to purchase the goods in advance, the information being information for moving to a dedicated page for purchasing the goods.

### Addendum 17

In the non-transitory storage medium according to Addendum 15 or 16, the plurality of vehicles may transport visitors from a predetermined departure place to the event site; and the functions may further include, when the number of the goods purchasers exceeds the threshold, shifting, at least by the predetermined period of time, departure time from the predetermined departure place and arrival time at the event site of each of the plurality of vehicles.

### Addendum 18

In the non-transitory storage medium according to any one of Addenda 15 to 17, the functions may further include, when the number of the goods purchasers exceeds the threshold, designating, for each of the vehicles, a shop at which each of the goods purchasers receives the goods.

### Addendum 19

In the non-transitory storage medium according to any one of Addenda 15 to 18, the number of the plurality of vehicles may be obtained by rounding up a value to the closest whole number, the value being obtained by dividing the number of the goods purchasers by the threshold.

### Addendum 20

In the non-transitory storage medium according to any one of Addenda 15 to 19, the functions may further include recording identification information of each of the plurality of visitors, a visit history, and a goods purchase history at each visit in association with one another.

What is claimed is:

1. An information processing apparatus that plans a service schedule of a plurality of vehicles that transport a plurality of visitors to an event site, the information processing apparatus comprising a processor configured to execute:
receiving advance purchase of goods to be sold at the event site from the plurality of visitors;
setting a threshold for a total value of upper limit numbers of people, the upper limit number being a number up to which the goods can be handed over per a predetermined period of time at each of one or more shops at the event site;
when the number of goods purchasers purchased the goods in advance exceeds the threshold, distributing the goods purchasers such that the goods purchasers in number smaller than or equal to the threshold get a ride on each of the plurality of vehicles; and
planning the service schedule of the plurality of vehicles such that the number of goods purchasers who concurrently arrive at the event site does not exceed the threshold.

2. The information processing apparatus according to claim 1, further comprising a communication unit communicably connected to mobile terminals held by the visitors wherein
the communication unit is configured to send information to the mobile terminals to prompt the visitors to purchase the goods in advance, the information being information for moving to a dedicated page for purchasing the goods.

3. The information processing apparatus according to claim 1, wherein:
the plurality of vehicles transport visitors from a predetermined departure place to the event site; and
the processor is configured to, when the number of the goods purchasers exceeds the threshold, shift, at least by the predetermined period of time, departure time from the predetermined departure place and arrival time at the event site of each of the plurality of vehicles.

4. The information processing apparatus according to claim 1, wherein the processor is configured to, when the number of the goods purchasers exceeds the threshold, designate, for each of the vehicles, a shop at which each of the goods purchasers receives the goods.

5. The information processing apparatus according to claim 1, wherein the number of the plurality of vehicles is obtained by rounding up a value to the closest whole number, the value being obtained by dividing the number of the goods purchasers by the threshold.

6. The information processing apparatus according to claim 1, further comprising a memory configured to record identification information of each of the plurality of visitors, a visit history, and a goods purchase history at each visit in association with one another.

7. The information processing apparatus according to claim 6, wherein the processor is configured to:
estimate the number of prospective customers that have not purchased the goods in advance and that have purchased goods in the same category as the goods at any one of event sites before, based on the goods purchase history at each visit of each of the plurality of visitors; and
when a total of the number of the goods purchasers and the number of the prospective customers exceeds the threshold, distribute the goods purchasers and the prospective customers such that the goods purchasers in number smaller than or equal to the threshold, the prospective customers in number smaller than or equal to the threshold, or a combination of the goods purchasers and the prospective customers in number smaller than or equal to the threshold get a ride on each of the plurality of vehicles.

8. An information processing method executed by an information processing apparatus that plans a service schedule of a plurality of vehicles that transport a plurality of visitors to an event site, the information processing apparatus including a processor and a memory, the information processing method comprising:
receiving, by the processor, advance purchase of goods to be sold at the event site from the plurality of visitors;
setting, by the processor, a threshold for a total value of upper limit numbers of people, the upper limit number being a number up to which the goods can be handed over per a predetermined period of time at each of one or more shops at the event site;
when the number of goods purchasers purchased the goods in advance exceeds the threshold, distributing, by the processor, the goods purchasers such that the goods purchasers in number smaller than or equal to the threshold get a ride on each of the plurality of vehicles; and
planning, by the processor, the service schedule of the plurality of vehicles such that the number of goods purchasers who concurrently arrive at the event site does not exceed the threshold.

9. The information processing method according to claim 8, further comprising sending, by the processor, information to mobile terminals held by the visitors to prompt the visitors to purchase the goods in advance, the information being information for moving to a dedicated page for purchasing the goods.

10. The information processing method according to claim 8, wherein:
the plurality of vehicles transport visitors from a predetermined departure place to the event site; and
the information processing method further comprises, when the number of the goods purchasers exceeds the threshold, shifting, by the processor, at least by the predetermined period of time, departure time from the predetermined departure place and arrival time at the event site of each of the plurality of vehicles.

11. The information processing method according to claim 8, further comprising, when the number of the goods purchasers exceeds the threshold, designating, by the processor, for each of the vehicles, a shop at which each of the goods purchasers receives the goods.

12. The information processing method according to claim 8, wherein the number of the plurality of vehicles is obtained by rounding up a value to the closest whole number, the value being obtained by dividing the number of the goods purchasers by the threshold.

13. The information processing method according to claim 8, further comprising recording, by the memory, identification information of each of the plurality of visitors, a visit history, and a goods purchase history at each visit in association with one another.

14. The information processing method according to claim 13, further comprising:
estimating, by the processor, the number of prospective customers that have not purchased the goods in advance and that have purchased goods in the same category as the goods at any one of event sites before, based on the goods purchase history at each visit of each of the plurality of visitors; and
when a total of the number of the goods purchasers and the number of the prospective customers exceeds the threshold, distributing, by the processor, the goods purchasers and the prospective customers such that the goods purchasers in number smaller than or equal to the threshold, the prospective customers in number smaller than or equal to the threshold, or a combination of the goods purchasers and the prospective customers in number smaller than or equal to the threshold get a ride on each of the plurality of vehicles.

15. A non-transitory storage medium storing instructions, the instructions being executable on a processor included in an information processing apparatus that is configured to plan a service schedule of a plurality of vehicles that transport a plurality of visitors to an event site, the instructions causing the processor to execute functions comprising:
receiving advance purchase of goods to be sold at the event site from the plurality of visitors;
setting a threshold for a total value of upper limit numbers of people, the upper limit number being a number up to which the goods can be handed over per a predetermined period of time at each of one or more shops at the event site;
when the number of goods purchasers purchased the goods in advance exceeds the threshold, distributing the goods purchasers such that the goods purchasers in number smaller than or equal to the threshold get a ride on each of the plurality of vehicles; and
planning the service schedule of the plurality of vehicles such that the number of goods purchasers who concurrently arrive at the event site does not exceed the threshold.

16. The non-transitory storage medium according to claim 15, wherein the functions further comprise sending information to mobile terminals held by the visitors to prompt the visitors to purchase the goods in advance, the information being information for moving to a dedicated page for purchasing the goods.

17. The non-transitory storage medium according to claim 15, wherein:
the plurality of vehicles transport visitors from a predetermined departure place to the event site; and
the functions further comprise, when the number of the goods purchasers exceeds the threshold, shifting, at least by the predetermined period of time, departure time from the predetermined departure place and arrival time at the event site of each of the plurality of vehicles.

18. The non-transitory storage medium according to claim 15, wherein the functions further comprise, when the number of the goods purchasers exceeds the threshold, designating, for each of the vehicles, a shop at which each of the goods purchasers receives the goods.

19. The non-transitory storage medium according to claim 15, wherein the number of the plurality of vehicles is obtained by rounding up a value to the closest whole number, the value being obtained by dividing the number of the goods purchasers by the threshold.

20. The non-transitory storage medium according to claim 15, wherein the functions further comprise recording identification information of each of the plurality of visitors, a visit history, and a goods purchase history at each visit in association with one another.
